(19) United States
(12) Patent Application Publication
(10) Pub. No.: US 2016/0055280 A1
(43) Pub. Date: Feb. 25, 2016

(54) SYSTEM FOR PREDICTIVE FAILURE ANALYSIS OF OFFSHORE PLATFORM PLACEMENT AND SAFE RECOVERY FROM RAPID LEG PENETRATION INCIDENTS

(71) Applicant: MATTHEWS-DANIEL COMPANY, Houston, TX (US)

(72) Inventors: S. Douglas Devoy, Houston, TX (US); Jose H. Vazquez, Houston, TX (US)

(21) Appl. No.: 14/464,331

(22) Filed: Aug. 20, 2014

(51) Int. Cl. G06F 17/50; E02B 17/00

(52) U.S. Cl. CPC G06F 17/5018; E02B 17/0034

(57) ABSTRACT

A tool to provide predictive analysis and component stresses of an offshore platform supported by platform support members as the offshore platform is being placed within a body of water. The tool comprising a computer processor, computer data storage, an input means, and an output means, which can all be in communication with the computer processor. The tool comprises a rig model library comprising at least one individual rig model, wherein each of the individual rig models comprises a finite element analysis of a specific offshore platform and a database comprising calculated component stress values for each of a plurality of offshore platform components, wherein each of the calculated component stress values incorporate the finite element analysis of the specific offshore platform and a plurality of predictive parameters for predicting mechanical stresses and analyzing failure potential for rig placement.

### FIELD

The present embodiments generally relate to a system for predicting mechanical stresses and analyzing failure potential for rig placement in addition to recovery steps and actions.

### BACKGROUND

Offshore platforms, such as jack up rigs and lift boats, can experience unexpected mechanical stresses and damage during placement when one support member, or leg, rapidly penetrates the soil and unbalances the platform.

Such rapid penetration events can be highly dangerous, causing injury or death to personnel, significant equipment damage, and substantial operational delays.

A need exists for a tool to predict stresses on an offshore platform and platform components in the event of a rapid leg penetration event to determine whether equipment has been damaged, and is safe to use.

A further need exists for a tool to recommend recovery actions and order of steps to recover from a rapid leg penetration event with minimal damage to the equipment.

The present embodiments meet these needs.

### BRIEF DESCRIPTION OF THE DRAWINGS

The detailed description will be better understood in conjunction with the accompanying drawings as follows:

FIG. 1 is a schematic representing the deployment of the tool.

FIG. 2 is a schematic representation of components of the tool.

FIG. 3 is a side view of a typical offshore platform.

FIG. 4 is a side view of a typical offshore platform experiencing a rapid penetration event of a support member.

The present embodiments are detailed below with reference to the listed Figures.

### DETAILED DESCRIPTION OF THE EMBODIMENTS

Before explaining the present system in detail, it is to be understood that the system is not limited to the particular embodiments and that it can be practiced or carried out in various ways.

Specific structural and functional details disclosed herein are not to be interpreted as limiting, but merely as a basis of the claims and as a representative basis for teaching persons having ordinary skill in the art to variously employ the present invention.

The present embodiments generally relate to the placement of offshore platforms, wherein the platforms have support members extending to a soil bed located under water. As used herein an offshore platform refers to jack up rigs of varying designs and lift boats of varying designs as typically used for offshore drilling applications.

Placement of these platforms can be problematic due to several uncontrolled variables. Failure to properly plan for contingent situations can result in sudden, unexpected, and undesirable consequences for worker safety, the environment, and the platform.

An illustrative case that is exemplary of the use and application of the present invention relates to the installation of an offshore jack up oil rig. While it can be utilized with many different platforms and platform designs, a jack up rig with three support members will be used to illustrate the embodiments of the present invention.

A typical embodiment of a jack up rig will have three support members, or legs, placed into a soil bed for supporting the platform. The legs penetrate into the soil until they are able to support the weight of the platform in a stable manner.

Prior to such a placement, analysis of the soil will be undertaken to determine the load bearing capabilities of various strata. As this analysis is both costly and time consuming, the soil data is extrapolated from a number of core samples extracted at or near the site of placement. Another method makes use of cone penetrometers, which are devices pressed into the soil at selected locations to measure load bearing capabilities of soil. Both methods rely upon extrapolation of data from the test or sample sites.

A load bearing profile of the soil or a soil profile at an installation site will then be extrapolated from the various core samples. Often this profile can be inaccurate based upon the location of the core sampling, or not representative of the soil characteristics at the exact location of the legs. The platform legs will often have a “spud can”, or foot for resting on the soil.

The soil profile will be used to predict the speed and amount of penetration of each leg of a platform. It is desirable to control the penetration of the legs and maintain a horizontal orientation of the platform. However, the potential inaccuracies from an extrapolated soil profile can make actual conditions during platform placement very unpredictable.

A highly dangerous situation can arise when one leg of the platform experiences a rapid penetration into the soil bed. Especially with regard to platforms with three legs, the rapid penetration of one leg severely unbalances the entire platform, causing an acute safety hazard to personnel, potentially resulting in an environmental impact, and causing millions of dollars of equipment damage and lost revenue due to delays in having an operational platform.

The effects resulting from rapid penetration of a leg are compounded by factors such as wind, current, and wave effects. Unique to each platform are characteristics such as the weight of the platform, longitudinal center of gravity, vertical center of gravity, and transverse center of gravity. It is desirable to predict damage or resultant stresses experienced by the platform due to a rapid leg penetration event.

It is desirable, therefore to predict the effects of various degrees of leg penetration and the effects on a specific platform mechanically, as well as structurally.

The present embodiments allow for a highly accurate means of predicting stresses and other effects on a platform and on platform components in the event of a rapid leg penetration incident. It provides a tool that can be used offline, or during an actual platform placement that predicts the stresses experienced by various components of a platform based upon inputted or actual parameters.

The present embodiments also allow for predicting the ideal recovery actions to be taken to recover from a rapid leg penetration event. Multiple actions can be modeled to determine specific actions and the order of actions to recover with the minimal amount of damage to the offshore platform.

This unique feature of the tool is possible due to the specific rig models and data incorporated into the tool. Unlike other predictive means currently utilized in the art, the tool is able to model offshore platform behavior when the offshore platform is partially submerged, while still accounting for environmental and other dynamic factors.

The present invention is a tool to provide an accurate predictive analysis and component stresses of an offshore platform supported by at least three platform support members as the offshore platform is being placed within a body of water. At least a portion of the platform support members penetrate soil, and continue to penetrate until they are stably supported.

The tool makes use of a computer having a computer processor and a computer data storage. The computer data storage comprises a non-transitory data storage medium such as a flash drive, a hard drive, a tape drive, and the like. As used herein, “computer data storage” excludes any transitory signals but includes any non-transitory data storage circuitry, e.g., buffers, cache, and queues, within transceivers of transitory signals.

The tool can have an input means for receiving data, user inputs, or other information. The input means can be a touch screen, a mobile device, a keyboard, an application program interface (hereinafter “API”), or any other suitable input means.

The tool can have an input means for transmitting data, corrective actions, or other information. The output means can be a display screen, a printout, an API, or any other suitable input means as desired.

The tool can have a rig model library comprising models of various specific platforms (“rig models”) that are to be placed. Each specific platform is analyzed using a finite element analysis of the platform. The analysis of the platform is highly detailed and allows for very accurate predictions of platform behavior under various conditions.

The rig model library can also have various design parameters of the rig, such as materials of construction, rated loads for various components, joint strengths, the weight of the platform, location of the longitudinal center of gravity, location of the vertical center of gravity, location of the transverse center of gravity, or other suitable parameters as desired by a user.

The rig models are highly specific, tailored to an individual platform, and contain sizable amounts of data that are compiled from various sources. The rig models can also contain calculated characteristics of the platforms that are beneficial to predicting platform behavior.

The tool can also have a database of calculated component stress values for numerous rig components based upon one or more predictive parameters, such as environmental parameters, support member stability parameters, platform height parameters, or rapid penetration parameters. Other suitable parameters for predicting platform behavior can also be included.

Rig components can include constituents such as joints, support chords, support braces, pinions, rack chocks, span breakers, or other components as desired. The components can be appropriately selected for determining what stresses or damage can occur to the rig in the event of a rapid leg penetration.

The tool uses structural analysis models of the platform at multiple elevations of the hull with respect to the spud cans and different boundary conditions. Boundary conditions include elements such as a fixity value for the support members, or the spud cans. Fixity refers to the level of pinning of the support members, and will be discussed in more detail below.

The rig models can include data modeling of all support chords, support braces, and other structural components, such as span breakers for the legs, connected to an equivalent platform. Various connection means can be employed, such as using upper and lower guide members, pinions, rack chocks, and appropriate member-end-releases.

To calculate component stress values, the tool accounts for abrupt changes in ground strength, overturning moment that the platform is subjected to and the axial force distribution at the spud can of a support member when it is subject to a rapid displacement or uneven soil support beneath the spud can.

The platform can be treated as a tall structure, which is subject to various stresses. Tall structures are flexible and can exhibit large lateral displacements in unusual circumstances. The lateral displacements of a platform can be caused by wind, current, wave action, or other forces. Given a lateral displacement of a platform, vertical loads on the support members can affect the ability of soil to hold the support member, thus potentially causing rapid vertical displacement of the supporting member. This loading creates a secondary moment on the support member, and is known as the P-Delta. The tool can incorporate P-Delta characteristics of the various platform components.

The tool can account for the P-Delta effects, as well as other dynamic forces experienced by the platform during a rapid leg penetration, such as buoyancy, environmental factors, and dynamic loading of the platform. The dynamic forces can have a natural period of effect, or otherwise change over time. Effects such as the dynamic frequency of waves, current, and wind can have significant impacts on the behavior of an offshore platform during placement, or during an upset condition.

The tool can handle dynamic amplification factors with varying mathematical methods of accounting for these factors, as well as use dampening constants. Wave, wind, and current loads are incorporated into the platform analysis and applied with varying methodologies based upon the specific application.

Environmental parameters can be selected to include any parameters that would affect the placement of the platform, or affect the behavior of the platform in the event of a rapid leg penetration occurrence. Environmental parameters can include wind parameters, wave parameters, current parameters, and the like.

Exemplary wind parameters that can be incorporated into calculations include wind speed, wind direction, wind gust factor, and the like.

Exemplary wave parameters that can be incorporated into calculations include wave height, wave speed, wave frequency, wave direction, wave specific gravity, wave water depth, wave breaking indication, and the like.

Exemplary current parameters that can be incorporated into calculations include current speed, current direction, current specific gravity, current water depth, current speed versus depth profile, and the like.

The support member stability parameter can indicate the degree of motion allowed to a platform support member or leg by the soil in which it is placed. Platform legs will often have a spud can for resting on the soil. The spud can acts as a type of foot that comes to rest upon the supporting soil. The support member stability parameter, in embodiments, can refer to the spud can, the leg, or both the spud can and the leg.

As used by persons having ordinary skill in the art, fixed indicates that the leg is held in place by soil or surrounding structures. Pinned indicates that the leg is freely moving with respect to soil or surrounding structures. A fixity value provides an intermediate parameter indicating the degree of fixture or pinning.

Exemplary support member stability parameters include a fixed specification, a pinned specification, or a fixity percentage or scaled value somewhere in the middle.

The offshore platform height parameter measures the height of the platform above a defined water level. As water level is often difficult to measure due to waves, a level will be determined and fixed to determine a consistent height measurement. Persons having ordinary skill in the art often refer to this as the “draft” or “air gap” of the platform.

The rapid penetration parameter, also referred to as “punch through” by persons having ordinary skill in the art, indicates a distance that a platform support member or leg penetrates through the soil rapidly. Each platform application can have its own definition of what constitutes “rapid”.

For example, a commonly used value to define “rapid” for a jack up rig, for example the value for “rapid” a MARATHON LETOURNEAU® 116-C rig is a leg penetrating soil at a rate greater than 1.5 feet per minute.

The rapid penetration parameter can be calculated based upon the soil profile, input by a user, API, or selected by any other suitable means.

The database can have pre-calculated stress values for a variety of platform components. The stress values can incorporate the predictive parameters in any combination or permutation.

In alternate embodiments, the computer processor can calculate values after they are inputted.

The tool can use computer instructions stored within the computer data storage to instruct the processor to receive the inputted predictive parameter or parameters and query the database to find component stress values calculated from matching predictive parameters.

If an exact match is found, the tool can provide the component stress values as an output. In addition, the tool can provide design characteristics of that various components, or perform a unity check to determine if all components are expected to stay within design limitations.

If an exact match is not found, the tool can then extrapolate component stress values from the existing values within the database.

In this manner, a variety of scenarios can be predictively planned for and the chance of success or failure of a platform placement can be predicted with great accuracy. Further, scenarios that will result in damage to the offshore platform can be modeled. Highly accurate prediction of what actual damage can occur are provided by the tool based upon specific parameters input.

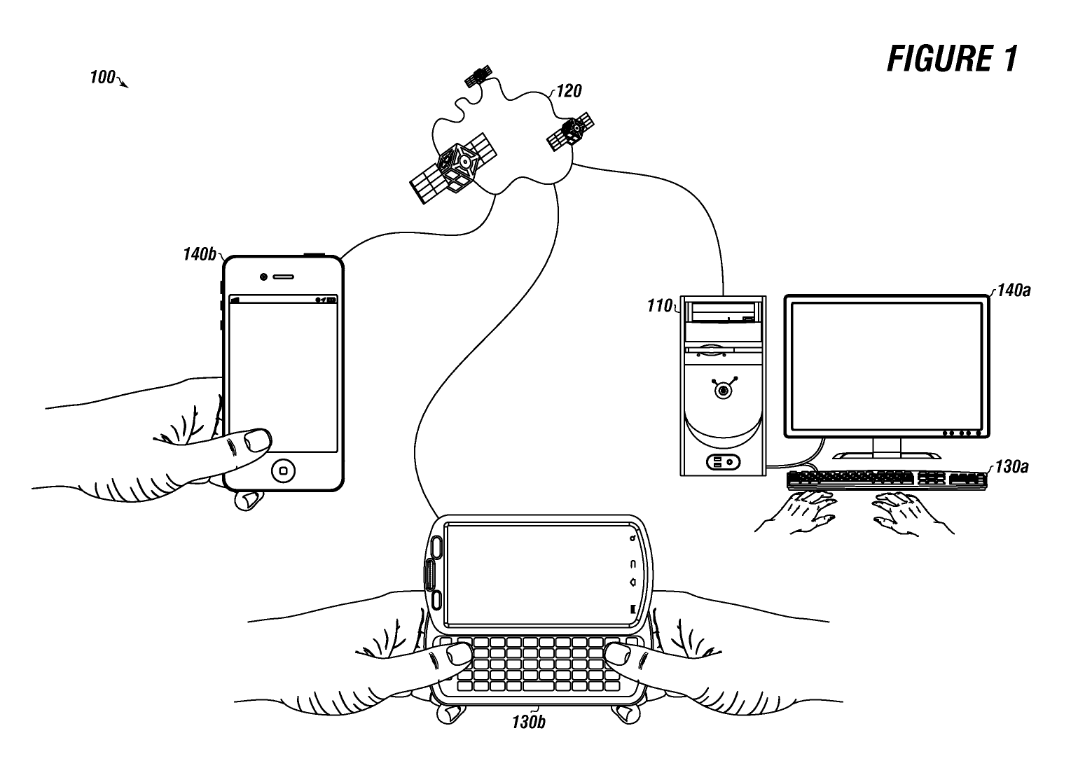

Turning now to the Figures, FIG. 1 is a schematic representing the deployment of the tool.

The tool 100 can reside on a computer 110. The computer 110 can comprise a computer processor and a computer data storage. The data storage can comprise a non-volatile data storage medium. A plurality of computer instruction can reside within the computer data storage.

The computer 110 can be connected to a network 120, such as a local area network, a wide area network, the internet, a satellite network, combinations thereof and the like. The tool 100 can comprise an input means 130a and 130b such as keyboard or a device connected to the network 120. Alternatively, inputs can be received from an application program interface (API) from a computer program.

The tool 100 can comprise an output means 140a and 140b such as a screen or a display device connected to the network 120. Alternatively, outputs can be transferred to the application program interface (API) of a computer program.

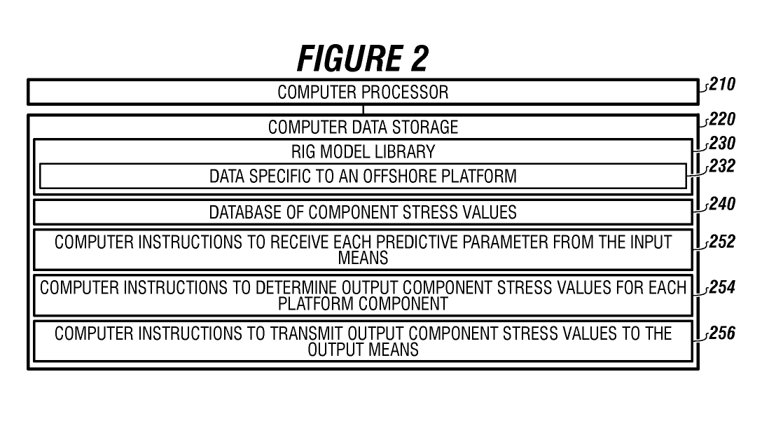

FIG. 2 is a schematic representation of components of the tool.

The tool can have a computer processor 210 in communication with a computer data storage 220. The computer data storage 220 can comprise a rig model library 230 which contains data specific to an offshore platform 232 requiring analysis.

The computer data storage 220 can further comprise a database of component stress values 240 for various components needing to be monitored. Exemplary components include joints, support chords, support braces, pinions, rack chocks, span breakers, or other components as desired.

The computer data storage 220 can further comprise a plurality of computer instructions.

The computer data storage 220 can contain computer instructions 252 to receive each predictive parameter from the input means.

The computer data storage 220 can contain computer instructions 254 to determine output component stress values for each platform component.

The computer data storage 220 can contain computer instructions 256 to transmit output component stress values to the output means.

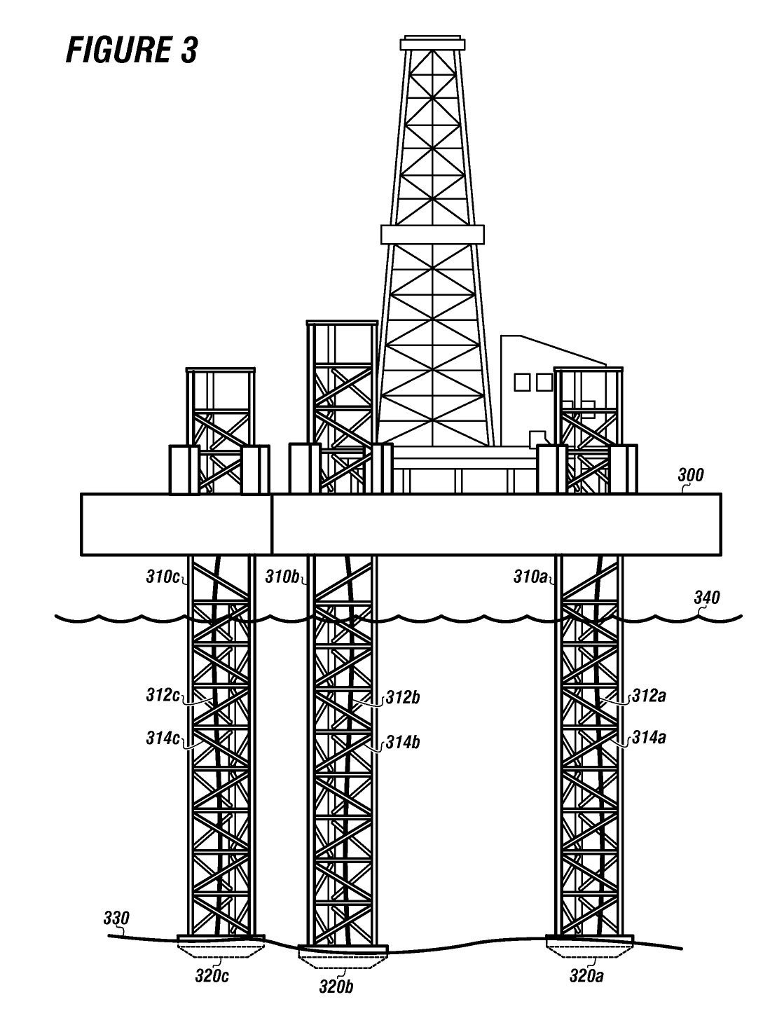

FIG. 3 is a side view of a typical offshore platform.

Shown here is a three legged jack up rig. The jack up rig can comprise an offshore platform 300 supported by at least three platform support members 310a, 310b, and 310c. The platform support members can have various components such as chords 312a, 312b, and 312c and braces 314a, 314b, and 314c.

Shown in this embodiment, the offshore platform is utilizing spud cans 320a, 320b, and 320c. The spud cans 320a, 320b, and 320c are shown partially buried in soil 330. The offshore platform is shown raised above the water level 340

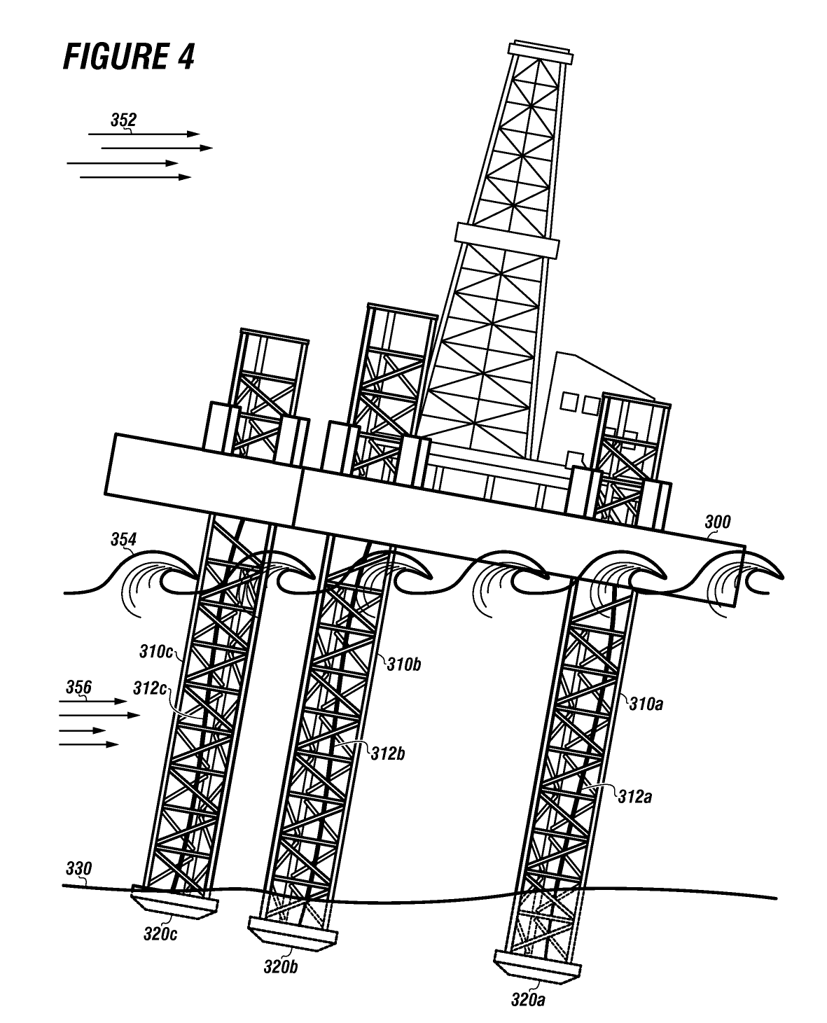

FIG. 4 is a side view of a typical offshore platform experiencing a rapid penetration event of a platform support member.

FIG. 4 depicts the offshore platform 300 when experiencing a rapid penetration event of platform support member 310a. Platform support members 310b and 310c remain substantially in the same location as depicted in FIG. 3. However, platform support member 310a has “punched through” a layer of soil 330 that is not capable of supporting its load.

This causes the offshore platform 300 to become partially submerged in water, and results in extremely high stresses and strains in various components of the jack up rig, such as chords 312a, 312b, and 312c.

These stresses and strains are further compounded by environmental and dynamic factors such as wind 352, waves 354, or current 356. The level of fixity of spud cans 320a, 320b, and 320c also affect the behavior of the offshore platform, and the stresses that platform components are subject to.

The tool allows for modeling highly specific to an individual offshore platform when subjected to an event as depicted in FIG. 4. Highly accurate predictions of resultant damage in various scenarios can be modeled.

Further, the tool's capability of modeling platform behavior even when submerged allows for step by step recovery actions to be modeled in order to determine the optimum course of action to right a platform after a rapid penetration event.

The tool not only allows for proper planning to ensure that potential rapid penetration events do not exceed design parameters, but also allows for safe recovery of an offshore platform in the event of an unforeseen event.

While these embodiments have been described with emphasis on the embodiments, it should be understood that within the scope of the appended claims, the embodiments might be practiced other than as specifically described herein.

What is claimed is:

1. A tool to provide predictive analysis and component stresses of an offshore platform supported by at least three platform support members as the offshore platform is being placed within a body of water, wherein at least a portion of the platform support members penetrate soil, and further wherein the tool comprises:
a. a computer processor;
b. a computer data storage in communication with the computer processor;
c. an input means in communication with the computer processor;
d. an output means in communication with the computer processor;
e. a rig model library within the computer data storage comprising at least one individual rig model, wherein each of the individual rig models comprises a finite element analysis of a specific offshore platform;
f. a database stored within the computer data storage comprising a plurality of calculated component stress values for each of a plurality of offshore platform components, wherein each of the calculated component stress values incorporate the finite element analysis of the specific offshore platform and a plurality of predictive parameters comprising:
(i) an offshore platform height parameter, wherein the offshore platform height parameter is a measured height of the offshore platform above a defined water level;
(ii) a rapid penetration parameter;
(iii) a longitudinal center of gravity;
(iv) a vertical center of gravity;
(v) a transverse center of gravity;
(vi) a platform weight; and
(vii) a water depth; and
g. computer instructions within the computer data storage instructing the computer processor to:
(i) receive each predictive parameter from the input means;
(ii) determine an output component stress value for each offshore platform component by:
(1) exactly matching the plurality of predictive parameters to the plurality of calculated component stress values; or
(2) calculating the plurality of component stress values using a plurality of component stress values for other parameters similar to the plurality of predictive parameters; and
(iii) transmit the output component stress value to the output means.

2. The tool of claim 1, wherein the plurality of predictive parameters further comprises an environmental parameter comprising:
(i) a wind parameter;
(ii) a wave parameter; or
(iii) a current parameter.

3. The tool of claim 1, wherein each of the calculated component stress values further incorporate:
a. a P-Delta characteristic;
b. a dynamic adjustment factor for the environmental parameter; and
c. a support member stability characteristic.

4. The tool of claim 1, wherein the database further comprises a diffraction run of the offshore platform based upon a rapid penetration value of one support member of the offshore platform and at least a portion of the offshore platform is at or below the defined water level.

5. The tool of claim 1, wherein the input means comprises:
a. a user input mechanism; or
b. an application program interface to receive data.

6. The tool of claim 1, wherein the output means comprises:
a. a display; or
b. an application program interface to transmit data.

7. The tool of claim 1, wherein the wind parameter comprises:
a. a wind direction;
b. a wind speed;
c. a wind direction; or
d. a gust factor.

8. The tool of claim 7, wherein a scaling factor is applied to the wind parameter.

9. The tool of claim 1, wherein the wave parameter comprises:
a. a wave height;
b. a wave speed;
c. a wave frequency;
d. a wave direction;
e. a wave specific gravity;
f. a wave water depth; or
g. a wave breaking indication.

10. The tool of claim 9, wherein a scaling factor is applied to the wave parameter.

11. The tool of claim 1, wherein the current parameter comprises:
a. a current speed;
b. a current direction;
c. a current specific gravity;
d. a current water depth; or
e. a current speed versus depth profile.

12. The tool of claim 11, wherein a scaling factor is applied to the current parameter.

13. The tool of claim 1, wherein the support member stability parameter comprises:
a. a fixed specification;
b. a pinned specification; or
c. a fixity value.

14. The tool of claim 13, wherein a scaling factor is applied to the support member stability parameter.

15. The tool of claim 1, wherein the offshore platform components comprise:
a. a support chord;
b. a support brace;
c. a pinion;
d. a rack chock;
e. a span breaker; or
f. a joint.

16. The tool of claim 1, further comprising an engineering design database, wherein the engineering design database comprises design characteristics for each of the offshore platform components and offshore platforms.

17. The tool of claim 16, further comprising computer instructions within the computer data storage instructing the processor to:
a. determine if the output component stress value exceeds the design characteristics for each of the offshore platform components for a given predictive parameter;
b. calculate a recommended corrective action; or
c. transmit the corrective action to the output means.

18. The tool of claim 16, further comprising:
a. a data log of events occurring during a rapid penetration event;
b. an analysis capability of various recovery actions; and
c. a prediction of a best mode of recovery.

19. The tool of claim 16, further comprising a situational simulation module, wherein the situational simulation module comprises:
a. a simulation of a plurality of rapid penetration events for a plurality of offshore platforms; and
b. a simulation of results from a plurality of rectification actions.
